(19) United States
(12) Patent Application Publication
(10) Pub. No.: US 2014/0289073 A1
(43) Pub. Date: Sep. 25, 2014

(54) Product Localization and Interaction

(71) Applicant: Steven K. Gold, Lexington, MA (US)

(72) Inventor: Steven K. Gold, Lexington, MA (US)

(21) Appl. No.: 14/217,717

(22) Filed: Mar. 18, 2014

Related U.S. Application Data
(63) Continuation of application No. 14/212,394, filed on Mar. 14, 2014.
(60) Provisional application No. 61/783,469, filed on Mar. 14, 2013.
(60) Provisional application No. 61/793,805, filed on Mar. 15, 2013.

(51) Int. Cl. G06Q 30/06

(52) U.S. Cl. CPC G06Q 30/0639
USPC 705/26.9

(57) ABSTRACT

The present invention provide systems and methods for the display of a prompt on a mobile device display; receipt of an indication of a selection of the prompt by a user; the display of a map showing the nearby locations for products and services, for example; a determination that a user has relocated to one of these locations; and a determination that a user has engaged in a transaction relating to one of the products or services. Other embodiments of systems and methods of the present invention include means for determining and applying the preferences of a user.

### BACKGROUND

Brand mapping has become a common feature on mobile applications, including store finders and product finders. Examples of brand mapping are described, for example, in U.S. Pat. No. 7,768,395, entitled, “Brand Mapping,” issued on Aug. 3, 2010, and U.S. Pat. No. 8,106,766, entitled, “Brand Mapping,” issued on Jan. 31, 2012; each of which is incorporated by reference herein.

### SUMMARY

Embodiments of the present invention may be used to complete brand mapping using front-end and/or back-end systems and methods to improve the user experience and to provide increased benefits to mobile device users and businesses that seek to promote their products, services and locations by means of mobile devices.

Embodiments of the present invention increase the utility and value of brand mapping, including benefiting end users and businesses that seek to promote their products, services, and locations by means of mobile advertising methods that drive consumer traffic and increase revenue. In addition, embodiments of the present invention may also include, make use of, integrate with, or otherwise be combined with the teachings of U.S. Prov. Pat. App. Ser. No. 61/783,469, filed on Mar. 14, 2013, entitled, “Presentation, Selection, Visualization and Redemption of Consumer Transactions” which is hereby incorporated by reference herein.

One embodiment of the present invention is directed to a method comprising: (a) at a first device first input means receiving first information relating to a deal in order to facilitate a precommitment to the deal; (b) at a second device outputting second information relating to the deal that has been precommitted to, the second information co-presented, using a second device output means, with an orienting image. The method may further include redeeming the deal.

The first device may, for example, be a computer, a wireless device, a smartphone, and/or a wearable wireless communication device (e.g., Google Glass or a similar device). The same is true of the second device. The first and second devices may be the same or distinct devices. The first information may be received using first input means, such as individual key input means (e.g., an alphanumeric keypad), an interactive touch screen technology input means, human voice reception input means, human gesture reception input means, and/or movement perception input means.

The first information may include an indication of an acceptance of a deal. The deal may be an economic transaction, such as a cost to a user (e.g., prepayment of some amount of money or currency), a benefit to a user (e.g., a discount on the price of products or services, as specified in a deal offer, applicable to the amount of the prepayment), a transaction that is asynchronous (e.g., the cost precedes the benefit).

The second information may include an available balance of funds (or value) remaining to be used (e.g., amount of economic value or credit available to be spent relative to the deal) and/or at least one detail relating to the deal (e.g., the discount amount or other benefit).

The orienting image may include a street map, an interior store map and/or a projected image. The orienting image may be caused to appear in a manner that allows a user to see through the surface displaying the orienting image in order to see the real world beyond. The orienting image may include a holographic image. The orienting image may include a representation of reality. The orienting image may include information that relates to the location of a user, such as information that relates to the spatial context of the user.

The co-presentation may include information (e.g., deal-related information) on a street map, a projection (or superimposition) of information onto a view of the real world, and/or a display of information (e.g., deal-related information) next to a view of the real world. The output means may include a transparent display and/or a speaker.

The precommitment may include an expression of interest in the deal or a prepurchase. The prepurchase may include a first entity (e.g., a person, user, or consumer) engaging in an economic transaction (e.g., contemplated or completed) that involves user awareness (e.g., of the deal and its features) along with an ability to redeem (e.g., actuate or exercise) the deal in order for a user to derive some benefit or perceived benefit. The prepurchase may be redeemed following the prepurchase in order for a user to derive benefit from the prepurchase.

The co-presentation of the second information may be dependent on a condition. The condition may include the location of the first device, the day of the week, the time of the day, and/or the weather.

Another embodiment of the present invention is directed to a method including: (a) at a wireless communication device, providing a deal presentation relating to a first deal using an output means of the device; (b) at the device, receiving an indication by a user, by means of input means of the device, of a selection of the first deal; (c) providing a deal visualization; and (d) facilitating deal redemption.

Yet another embodiment of the present invention is directed to a system including: a first device for presenting a deal presentation relating to a first deal; a first input means at the first device for receiving an indication of a selection of the first deal; a second device comprising output means for presenting a deal visualization at the output means; and, at the second device, a means for deal redemption.

Yet another embodiment of the present invention is directed to a method comprising: (a) at a device first input means receiving an indication of a selection of a first deal in order to facilitate implementation of the first deal; (b) at the device first output means outputting second information relating to the deal that has been selected, such information co-presented on the output means along with an orienting image. The method may further include: (c) enabling the redemption of the first deal. The method may further include redeeming the first deal using means comprising near-field communication technology, means comprising radio-frequency identification (RFID) technology, and/or means comprising bar code presentation technology. The method may further include redeeming the first deal to thereby facilitate the debiting of a value from a user account and the crediting of the value to a merchant account. The method may further include redeeming the first deal to thereby facilitate a benefit (e.g., a discount, a free product, or a free service) to a user of the first device. The redemption may occur at one time or in multiple instances over a period of time.

One embodiment of the present invention is directed to a method comprising: (a) displaying, using a wireless communication device, a first prompt; (b) receiving, from a user of the device, an indication of a selection of the first prompt; (c) identifying a location of the device independently of any location-specifying user input to the device; (d) wirelessly communicating, using the device, first data, the first data comprising information relating to the first location of the device; (e) wirelessly receiving, using the device, second data; (f) displaying, using the device, a map image that is based at least in part on the second data, wherein the first map image describes a first area overlapping with a location in proximity to the location of the device; (g) wherein the map image comprises a first indication of a location of a first brand access site at which a first branded entity having a first brand is accessible; (h) wherein the first indication is located at a first position on the map image corresponding to the location of the first brand access site; (i) following displaying of the map image, determining that the device has relocated to a location in proximity to the first brand access site; and (j) determining that a transaction relating to the first brand has occurred.

Another embodiment of the present invention is directed to a method comprising: (a) displaying, using a wireless communication device, a first prompt; (b) receiving, from a user of the device, an indication of a selection of the first prompt; (c) identifying a location of the device independently of any location-specifying user input to the device; (d) wirelessly communicating, using the device, first data, the first data comprising information relating to the first location of the device; (e) wirelessly receiving, using the device, second data; (f) displaying, using the device, a map image that is based at least in part on the second data, wherein the first map image describes a first area overlapping with a location in proximity to the location of the device; (g) wherein the map image comprises a first indication of a location of a first brand access site at which a first branded entity having a first brand is accessible; (h) wherein the first indication is located at a first position on the map image corresponding to the location of the first brand access site; (i) wherein the map image further comprises a second indication of a location of a second brand access site at which a second branded entity having the second brand is accessible; (j) wherein the second indication is located at a second position on the first map image corresponding to the location of the second brand access site; (k) following displaying of the map image, determining that the device has relocated to a location in proximity to the first brand access site; (l) using the device to facilitate a transaction relating to the first brand; and (m) determining that a transaction relating to the first brand has occurred.

Yet another embodiment of the present invention is directed to a method comprising: (a) determining at least one preference of a user associated with a wireless communication device; (b) displaying, using the device, a first prompt; (c) receiving, from a user of the device, an indication of a selection of the first prompt; (d) identifying a location of the device independently of any location-specifying user input to the device; (e) wirelessly communicating, using the device, first data, the first data comprising information relating to the first location of the device; (f) wirelessly receiving, using the device, second data; (g) displaying, using the device, a map image that is based at least in part on the second data, wherein the first map image describes a first area overlapping with a location in proximity to the location of the device; (h) wherein the map image comprises a first indication of a location of a first brand access site at which a first branded entity having a first brand is accessible; (i) wherein the first indication is located at a first position on the map image corresponding to the location of the first brand access site; (j) wherein the map image further comprises a second indication of a location of a second brand access site at which a second branded entity having the second brand is accessible; (k) wherein the second indication is located at a second position on the first map image corresponding to the location of the second brand access site; (l) following displaying of the map image, determining that the device has relocated to the first brand access site; (m) using the device to facilitate a transaction relating to the brand; and (n) determining that a transaction relating to the brand has occurred.

The method may further include using the device to facilitate a transaction relating to the first brand. The method may further include using the device to cause a transaction relating to the first brand. The transaction may be a purchase transaction. The map image may further include a second indication of a location of a second brand access site at which a second branded entity having the second brand is accessible, wherein the second indication is located at a second position on the first map image corresponding to the location of the second brand access site. The first prompt may include one or more of the following: an advertisement (such as a banner advertisement, a small format advertisement, or a medium format advertisement), a video, a sound, a vibration, a word, an image, and a logo. The prompt may be served remotely and/or wirelessly (e.g., using an ad server network).

The method may further include, prior to displaying the first prompt, displaying a second prompt. The second prompt may indicate a user preference. The second prompt may provide information for selection of which prompt, among a plurality of possible prompts, to select as the first prompt. The indication of a selection of the first prompt may include receiving a tactile input (such as input received by a touch-sensitive display) at the device. The indication of a selection of the first prompt may include receiving input, provided by a user, sensed by the device. The indication of a selection of the first prompt may include a sound (such as a sound created by a user of the device), a movement (such as a movement created by a user of the device), or a gesture (such as a gestured created by a user of the device). The determination that the device has relocated to the first brand access site may be made by the device, facilitated by the device, made by a device-located technology independent of the device, facilitated by a near-field communication (NFC) technology in communication with the device, or facilitated by a radiofrequency identification (RFID) technology communicating with the device. The determination that the device has relocated to the first brand access site may include an input by the user of the device, an input by a user other than the user of the device, a determination of the behavior of a user of the device, an analysis of the behavior of a user of the device.

Relocating to the first brand access site may include locating in proximity to the first brand access site, locating in proximity to a product or service of the first brand. Determining that a transaction relating to the brand has occurred may include determining an interest in a product or service associated with the first brand by a user of the device, determining that a user of a device has used the device to “like” or “favorite” a brand on a social network, determining an interaction with a product or service associated with the first brand by a user of the device, determining a purchase of a product or services associated with the first brand by a user of the device, integrating with a business's (merchant's) point of sale system, or integrating with a financial transaction processing system. The financial transaction processing system may process any one or more of the following: credit transactions, debit transactions, point-based transactions

Determining at least one preference of a user associated with the wireless communication device may include receiving input from a user at the device. The input may include an indication of a selection of a second prompt at the device, information received at the device as entered by a user of the device, information relating to the device location over time, information relating to the social network of a user, information relating to the brand preferences of a user, information relating to a purchase transaction history of the user, information relating to the preferences of other people within a social network of the user, information relating to advertisements that have been previously presented to a user, or information relating to promotions that have been previously presented to a user.

The prompt may include a small format advertisement that further includes an image inserted into a sentence or phrase; a small format advertisement that further includes a series of rotating or dynamic images; a small format advertisement that further includes a symbol alerting a user to the availability of the map; a medium format advertisement that further comprises a “drawer” that the user may select to expose an image. The drawer may represent the map. The drawer may be integrated into a mobile application. The drawer may be exposed by means of a swipe gesture of a finger of a user.

The transaction may include one or more of the following: a purchase, an exchange of value, an application of points, a reservation, and a use of a product. The use of the product may be detected by an element of the product and communicated by the product.

The first prompt may be displayed on the device upon a determination that a minimum number of brands of interest to a (likely) user of the device are located nearby. The first prompt may be displayed on the device upon a determination that at least one brand of predetermined interest to a (likely) user of the device is located nearby.

Determining that the device has relocated to the first brand access site and determining that a transaction relating to the first brand has occurred may be the same determination. Determining that the device has relocated to the first brand access site and determining that a transaction relating to the first brand has occurred may be performed using the same means.

The indication of the selection of the first prompt may include relocation of the device to the first brand access site and/or movement of the device toward the first brand access site.

The method may further include communicating information relating to the transaction to the device and displaying at least a portion of the information to a user on a display of the device. The information may include a receipt confirming the transaction and/or information relating to a new benefit triggered by the transaction.

The first prompt may include a brand-associated image and/or a logo of a brand.

Another embodiment of the present invention is directed to a method comprising: (a) displaying, using a wireless communication device, a first prompt; (b) receiving, from a user of the device, an indication of a selection of the first prompt; (c) wirelessly communicating, using the device, first data, the first data comprising information relating to a first location of the device; (d) wirelessly receiving, using the device, second data; (e) displaying, using the device, a map image that is based at least in part on the second data, wherein the first map image describes a first area overlapping with a location in proximity to the location of the device; (f) wherein the map image comprises a first indication of a location of a first brand access site at which a first branded entity having a first brand is accessible; (g) wherein the first indication is located at a first position on the map image corresponding to the location of the first brand access site; (h) wherein the map image further comprises a second indication of a location of a second brand access site at which a second branded entity having the second brand is accessible; (i) wherein the second indication is located at a second position on the first map image corresponding to the location of the second brand access site; (j) following displaying of the map image, determining that the device has relocated to the first brand access site; (k) using the device to facilitate a transaction relating to the first brand; and (l) determining that a transaction relating to the first brand has occurred.

Yet another embodiment of the present invention is directed to a method comprising: (a) displaying, using a wireless communication device, a first prompt; (b) receiving, from a user of the device, an indication of a selection of the first prompt; (c) identifying a location of the device independently of any location-specifying user input to the device; (d) wirelessly communicating, using the device, first data, the first data comprising information relating to the first location of the device; (e) wirelessly receiving, using the device, second data; (f) displaying, using the device, a map image that is based at least in part on the second data, wherein the first map image describes a first area overlapping with a location in proximity to the location of the device; (g) wherein the map image comprises a first indication of a location of a first brand access site at which a first branded entity having a first brand is accessible; (h) wherein the first indication is located at a first position on the map image corresponding to the location of the first brand access site; (i) following displaying of the map image, determining that the device has relocated to the first brand access site; (j) using the device to facilitate a transaction relating to the first brand; and (k) determining that a transaction relating to the first brand has occurred.

A further embodiment of the present invention is directed to a method comprising: (a) displaying, using a wireless communication device, a first prompt; (b) receiving, from a user of the device, an indication of a selection of the first prompt; (c) wirelessly communicating, using the device, first data, the first data comprising information relating to a first location of the device; (d) wirelessly receiving, using the device, second data; (e) displaying, using the device, a map image that is based at least in part on the second data, wherein the first map image describes a first area overlapping with a location in proximity to the location of the device; (f) wherein the map image comprises a first indication of a location of a first brand access site at which a first branded entity having a first brand is accessible; (g) wherein the first indication is located at a first position on the map image corresponding to the location of the first brand access site; (h) following displaying of the map image, determining that the device has relocated to the first brand access site; (i) using the device to facilitate a transaction relating to the first brand; and (j) determining that a transaction relating to the first brand has occurred.

Yet a further embodiment of the present invention is directed to a method comprising: (a) determining a trigger; (b) identifying a location of the device independently of any location-specifying user input to the device; (c) wirelessly communicating, using the device, first data, the first data comprising information relating to the first location of the device; (d) wirelessly receiving, using the device, second data; (e) based on the trigger, displaying, using the device, a map image that is based at least in part on the second data, wherein the first map image describes a first area overlapping with a location in proximity to the location of the device; (f) wherein the map image comprises a first indication of a location of a first brand access site at which a first branded entity having a first brand is accessible; (g) wherein the first indication is located at a first position on the map image corresponding to the location of the first brand access site; (h) wherein the map image further comprises a second indication of a location of a second brand access site at which a second branded entity having the second brand is accessible; (i) wherein the second indication is located at a second position on the first map image corresponding to the location of the second brand access site; (j) following displaying of the map image, determining that the device has relocated to the first brand access site; (k) using the device to facilitate a transaction relating to the first brand; and (l) determining that a transaction relating to the first brand has occurred. The trigger may include a location of the device, proximity to a brand access site, or a movement of the device.

Yet another embodiment of the present invention is directed to a method comprising: (a) identifying a location of a wireless communication device independently of any location-specifying user input to the device; (b) wirelessly communicating, using the device, first data, the first data comprising information relating to the first location of the device; (c) wirelessly receiving, using the device, second data; (d) displaying, using the device, a first image that is based at least in part on the second data; (e) wherein the first image comprises a first indication of a location of a first brand access site at which a first branded entity having a first brand is accessible; (f) following displaying of the first image, determining that the device has relocated to a location in proximity to the first brand access site; and (g) determining that a transaction relating to the first brand has occurred. The device may include a headset device or a Google Glass™ device or similar device. The first image may include a logo. The method may operate on a second image that is different from the first image. The second image may include a logo. The first image and the second image may be displayed concurrently or sequentially. The first indication may include an indication of a direction to a brand access site. The method may further include displaying, on a display of the device, information comprising a confirmation of the transaction (such as a receipt). The method may further include displaying, on a display of the device, information comprising information relating to a benefit that has been triggered by the transaction. The method may further include displaying, on a display of the device, information comprising information relating to a promotion that may be redeemed at the brand access site.

Another embodiment of the present invention is directed to a system comprising: a wireless communication device; means for displaying a first prompt; means for receiving, from a user of the device, an indication of a selection of the first prompt; means for identifying a location of the device independently of any location-specifying user input to the device; means for wirelessly communicating, using the device, first data, the first data comprising information relating to the first location of the device; means for wirelessly receiving, using the device, second data; means for displaying, using the device, a map image that is based at least in part on the second data, wherein the first map image describes a first area overlapping with a location in proximity to the location of the device; means for determining that the device has relocated to a location in proximity to the first brand access site; and means for determining that a transaction relating to the first brand has occurred.

Yet another embodiment of the present invention is directed to a system comprising: means for identifying a location of a wireless communication device independently of any location-specifying user input to the device; means for wirelessly communicating, using the device, first data, the first data comprising information relating to the first location of the device; means for wirelessly receiving, using the device, second data; means for displaying, using the device, an first image that is based at least in part on the second data; means for determining that the device has relocated to a location in proximity to the first brand access site; and means for determining that a transaction relating to the first brand has occurred.

### BRIEF DESCRIPTION OF THE DRAWINGS

FIG. 1 illustrates a method according to one embodiment of the present invention;

FIGS. 2A-2B show two embodiments of portable communication devices according to the present invention;

FIGS. 3A-1 and 3A-2 show embodiments of deal presentations of the present invention;

FIG. 3B shows an embodiment of deal presentation as it may appear looking next to the display of a Google Glass™-type device;

FIG. 3C shows a user interaction to opt in to a deal according to one embodiment of the present invention;

FIGS. 4A-4B show deal visualizations according to embodiments of the present invention;

FIGS. 5A-1, 5A-2, and 5A-3 show deal redemption according to embodiments of the present invention;

FIG. 6 shows deal monitoring according to one embodiment of the present invention;

FIG. 7 shows a method according to one embodiment of the present invention;

FIG. 8 shows a system according to one embodiment of the present invention;

FIG. 9 is a flowchart of a method performed according to one embodiment of the present invention;

FIG. 10 is a flowchart of a method performed according to another embodiment of the present invention;

FIG. 11 is a representation of an embodiment of a system of the present invention; and

FIG. 12 is a representation of another embodiment of a system of the present invention.

### DETAILED DESCRIPTION

Embodiments of the present invention include systems which include means for performing, and methods which perform, deal presentation, deal opt-in (including precommitment, which may be or include a prepurchase), deal visualization (which may be implemented in any of a wide variety of way), deal redemption (e.g., the securing of a deal or certain benefits by a user), and deal monitoring (including, but not limited, creating reports or facilitating analyses), or any subset or combination thereof. In one embodiment, users are provided with a way to discover, opt in, visualize, and then redeem deals (e.g., promotions), using a mobile device—such as a smartphone or Google Glass™ (or similar) device—in order to facilitate part or all of the process. Embodiments of the present invention may benefit users and businesses such as stores and restaurants.

As used herein, the term “deal” includes, for example, any promotion or other economic transaction (e.g., contemplated or completed) that involves user awareness (of the deal and its features, e.g., a specific discount or other commercial terms) along with an ability to redeem (e.g., actuate and/or exercise) the deal in order for a user (who may also be described as a customer or consumer) to derive some benefit or perceived benefit. As one example, a deal may be an offer by Company X for a user to purchase product Y at a Z % discount prior to some date. As another example, a deal may be conditional, such as if a user precommits to the deal (e.g., prepaying for, liking, or otherwise promoting a company or a brand on a social network), then the user receives some (future, post-precommitment) benefit(s). One example of this conditional type of deal is the following: if a user prepays $50 (e.g., the amount charged to the user's credit card or otherwise contractually committed, owed or paid) to Company Y, then the user receives a 20% discount on all purchases of specified products and/or services manufactured or sold by Company Y (e.g., those specified as being of a particular brand and/or purchasable within a particular brand of stores or a particular retail location) that are bought with the precommitted funds, e.g., the $50, whether these funds are expended all at once, or over time. In yet another example of a conditional type of deal, a user may simply express interest in a particular company, brand, product, service or location and (in exchange for that expression of interest) receive certain benefits. Examples of benefits that may be secured by, and accrue to, a user in any deal include discounts, gifts, special service, co-promotions, x-for-y offers, individual recognition, and more. Many forms and formats of deals are possible and anticipated by embodiments of the present invention.

One embodiment of a deal involves a precommitment by a user. In one embodiment, a precommitment may be an expression of interest in a brand, product, service or a location. Interest in other subjects and things is also possible. In another embodiment, a precommitment may be an expression of intent to engage in a deal or otherwise engage with a brand, product, service or location. In another embodiment, a precommitment may include a prepurchase. One example of an embodiment of a prepurchase engagement is an economic transaction whereby money (or other consideration, e.g., points or virtual currency) is applied (somehow precommitted, either reversibly or irreversibly) in advance of a future purchase or use of products or services, whereby certain benefits are provided in exchange for the precommitment (e.g., prepurchase). These products or services may be associated with a particular brand, or may be associated with a particular product, service, set of products, set of services, branded location or set of locations, e.g., a chain of retail stores. Examples of benefits include free products, free services, discounted products, discounted services, and other forms of tangible and intangible value. As implied by the terms “precommitment” and “prepurchase,” a commitment or purchase is made by a user prior to the time when the same user may redeem or realize at least some of the anticipated or associated benefits, for example. Embodiments of the present invention may also facilitate or enable transfer of such benefits from one user to another, such as from one member of a social network to another member of a social network, this being facilitated in any of a variety of ways, including an electronic exchange.

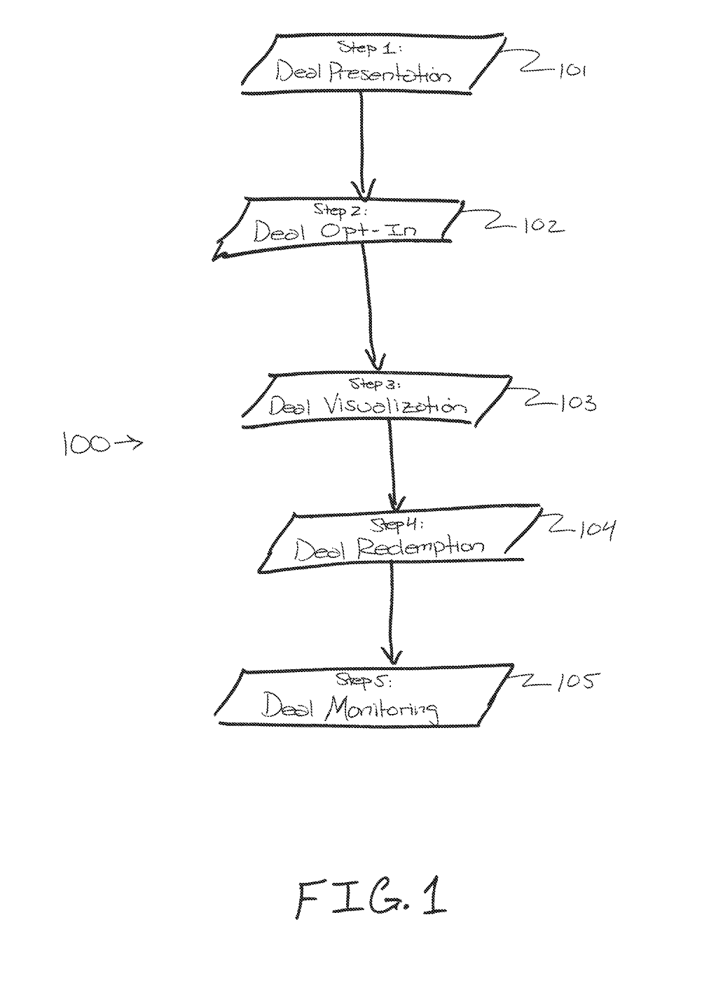

FIG. 1 is a flowchart of a method 100 performed by one embodiment of the present invention. In this drawing figure, five operations 101-105 are shown. Any or all of these five operations 101-105 may be applied in the order shown or in other orders. Furthermore, embodiments of the invention may make use of all five operations 101-105, or some subset of the five operations 101-105, possibly without regard to any particular sequence. Variations in this and other described methods are within the scope of embodiments of the present invention.

Operation 101 includes presenting a deal (i.e., deal presentation). Deal presentation includes, for example, presenting a commercial offer (e.g., deal, promotion) to a user. Operation 101 may be performed in any of a variety of ways, including (for example) presenting deal-related information on a display of a wireless mobile device such as a smart phone (e.g., iPhone), Google Glass™ or similar (wearable) device, or desktop computer. Such presentation may also be spoken in full or in part, such as information spoken to a user of a device, or otherwise presented using visual, auditory, and/or tactile output such that deal-related information is communicated to a user.

In the case where an embodiment of deal presentation is visually displayed, such visual display may be in the form of a display of each individual deal (including its details, for example), a list of deals, or a presentation of one or more deals on a map. A map may be in two dimensions (e.g., a Google Map that is shown on an iPhone™ 5 display), three dimensions (hologram), or exist as a view that is superimposed, projected, imputed, or imprinted on a view of the real world, such as may be the case using a wearable headset device with a see-through display that enables a user to see a co-presentation of deal-related information, for example, with an orienting image, e.g., the view of the real world beyond (perhaps similar to a future version of Google Glass™). In addition, an interior map (representing the interior of a store, for example), or other types of map and other presentations are possible. Deal-related information may be layered (overlaid) on such a visual presentation, superimposed, projected, imputed, and/or communicated to a user in any way or manner that enables a user to perceive and process such information. In one embodiment, deal-related information is presented on a street map. In another embodiment, deal-related information is presented on an interior map. In yet another embodiment, deal-related information is co-presented with an orienting image. In one embodiment, an orienting image is a map. In another embodiment, an orienting image is a view of the real world. In yet another embodiment, an orienting image is a view of the real world that is visualized on a display. In yet another embodiment, an orienting image is a view of the real world that is visualized through a display, e.g. a transparent display. Other embodiments of visualizations, visualization co-presentations, and orienting images are possible and fall within the scope of embodiments of the present invention.

Deal-related information may be simple or complex. In one embodiment, deal-related information includes one or more of the following: a cost (e.g., the price a user is being asked to pay), a benefit (e.g., the benefit a user receives for payment of the cost), and terms and/or conditions associated with the deal or offer. One example of a deal is: Pay $50 (now, as a prepayment) and receive free soda whenever you use this credit in our restaurant). Another example of a deal is: Pay $100 (now, as a prepayment) and receive a 20% discount on every purchase made in any of our stores using the prepayment amount, up to that amount. Yet another example of a deal is: Commit $200 (now, as a prepayment) and you are guaranteed to go straight to the front of the list to be seated at our restaurant as soon as possible. Yet another example of a deal is: Come into our store within the next hour and you will receive a free gift, but only if you let us know that you are coming (since the store will only be giving out gifts to the first 100 people to respond to the deal offer, for example). Many other deal structures are possible. Deals can relate to specific brands, products, services, sets of products, sets of services, locations, and more. Also, deal related information may also use other words and/or be presented in other formats, languages, etc., and may also include additional information such as any limitations, disclaimers, metadata, names or identities of other participants (e.g., members of a user's/person's social network who are either also interested in a particular deal or precommitted to that deal), and more. In addition, deal-related information may be presented using words, images, graphics, symbols (including those that represent common deal features), sounds, voice output, and more. Other embodiments and variations of deal presentation are possible and fall within the scope of embodiments of the present invention.

Deal-related information may be also presented in any of a variety of ways. In one embodiment, deal-related information is presented using words. In another embodiment, deal-related information is presented using graphics (e.g., images, icons). In yet another embodiment, deal-related information is presented using a combination of words and graphics. As noted before, such presentation of deal-related information need not be visual, and may involve a combination of presentation modalities, e.g., visual and audio (e.g., voice or sounds). It should also be noted that various icons, representations, graphics, images and sounds may be used to represent certain elements of deal-related information, either generally or specifically, possibly including specific deal terms (e.g., magnitude of a discount, time remaining). Metadata, alerts, reminders and more may also be presented.

Operation 102 involves opting in to a deal (deal opt-in). In general, the term “deal opt-in,” as used herein, includes, for example, any action, actions (or lack of action or actions) that a user takes (or that a device of the invention senses) and/or input that a user provides to a computing device that i) indicates or selects an interest in a deal, ii) indicates or selects a user's intention to engage with a brand, product, service or location, and/or iii) indicates or selects a precommitment. Generally, following operation 101 (deal presentation) a user may choose to receive (e.g., benefit from) that deal by means of deal opt-in, indication, or selection. Notably, a user may also opt in by simply not opting out of a deal (e.g., a user may have expressed prior interest in a brand or particular type of product or service, and deals may be made active unless de-activated by the user). The process of opting in to a deal may be accomplished in any of a wide variety of ways, in part depending on how the deal presentation in operation 101 was performed. For example, if deal presentation is implemented by presenting a list, a user may select (or leave selected) a particular deal presentation shown in such a list of (one or more) deal presentations. Alternatively, if the deal presentation is shown on a map—with information being conveyed either on the map, in a bubble that appears overlaid on the map, by words and/or graphics, by voice or other audio, or otherwise—then a user may select (or leave selected) one or more deals, possibly by selecting (e.g., clicking on or otherwise indicating by touch, gesture or voice, for example) an image or icon on or near the map image. If a deal presentation is shown on a Google Glass (or other similar wearable) display, for example, then a user may select the deal with a voice command. A variety of methods of selecting a particular deal presentation are possible an anticipated by the invention.

Such selection may be made, depending on the particular device and its capabilities for receiving input from a user, by touching the device or an interactive display or other element of a device, by spoken word, command, by making a sound, by doing or performing some sort of gesture, such as blinking, or another bodily gesture, by moving a device in a particular way, or by other means, or some combination these and other possible means and methods. In the case where a selection involves either multiple steps or more than one decision (or input), then a sequence or combination may employ any or all of these selection or indication means.

Following selection of a deal, whatever the means employed, the particular selected deal is then associated with a user (or the user's device). In the case where selection of a deal involves a prepayment, such prepayment may be facilitated at the time of selection of the deal (either as a single-step “one click” process, or involving multiple steps and possibly additional input by a user, such as input of a security code or a user's credit card information, or otherwise validating a transaction).

The selection of a deal by a user may lead to other actions or benefits, including the sharing of the deal with a user's social network, by means of an electronic social network such as Facebook, Twitter or others, for example. In an embodiment of the invention, deal presentations may be shared by a user with another user. In another embodiment, deal benefits are shared by a user with another user. In yet another embodiment, deal visualizations are shared by one user with another user. Again, such sharing may be implemented using any of a variety of means, from simple image or link sharing, to secure electronic transfer of currency or other valuable consideration from one user's account to another user's account by means of a network, account processing algorithms, and changes to a database.

Operation 103 involves visualizing a deal (deal visualization). In this operation, one or more previously selected deals associated with a particular user (e.g., deals previously selected by that user) and/or the user's device, may be visualized on that user's device (or even more than one device associated with a particular account, user or device). In one embodiment, a previously selected deal may be displayed on a list viewable on an electronic display of a mobile device. In another embodiment, deal-related information for a previously selected deal may be displayed (co-presented) with an orienting image that may be seen using a display of a mobile device. An orienting image may include or be, for example, a street map, interior map (possibly showing a representation of a store interior, for example), or other type of map or geospatial representation. In yet another embodiment of the invention, an orienting image may be an image of the real world with deal-related information projected, overlaid, displayed, superimposed, imputed or otherwise co-presented with or alongside such an orienting image.

Similar to initial deal presentation, deal visualization may use any of a variety of output means, including but not limited to visual displays, such as an electronic touch-sensitive display on a mobile device, or a projection or other display means on a wearable headset-type device. In addition, audio output devices (e.g., speakers), tactile output devices, and more, may be used to augment deal visualization. In one embodiment, deal visualization may involve the use of deal-related information including words and/or images that appear superimposed or overlaid (whether or not the image is actually served to the device in this manner) on a map presentation (e.g., Google Map) shown on an electronic device display on a mobile smartphone. In another embodiment, deal visualization may involve deal-related information being shown next to a map. In another embodiment, deal visualization on a wearable see-through device may include co-presentation of deal-related information as displayed by the device, along with an orienting image, which may, for example, be a user's view of the world through or beyond (or next to) the device. Visualization may be complemented by audio (possibly including a voice description or sounds, e.g., sounds to help located, hone in on, or describe a particular deal that has been previously selected by a user), and tactile information conveyed to a user by the device. In addition, other devices, device elements and mechanisms may facilitate deal visualization for a user.

Deal visualization may be used to help a user to ascertain the actual or relative location of a previously selected deal (e.g., a deal that the user opted into, selected or indicated), deal-related information (e.g., the amount of money or value remaining available to be spent at the particular location(s) or for a particular brand of product or service, or with a particular merchant or group of merchants; or representations of the benefits that may be available to the user), and/or any other information that helps a user discover (or even remember or recall) deals within an actual or relative geographic, visual or other context, locate those deals (e.g., a device may possibly help guide the user to a store, or even a shelf or product location within a store), so that the user may benefit from the deal. As previously mentioned, this process also benefits the sponsor of a particular deal, possibly by leading to increased awareness and additional revenue for the sponsor.

Operation 104 involves redeeming a deal (deal redemption). Deal redemption is the process by which a user who has previously selected (opted into) a deal, facilitates redemption of the deal. In one embodiment, deal redemption may be achieved by using the device, e.g., a smart phone or wearable communication device. In one embodiment, a device displays a bar code that may be read by a bar code reader in order to provide the merchant (either directly or indirectly) with information to enable or otherwise facilitate redemption of the deal. For example, if a user pre-purchased $50 worth of merchandise from a particular retail chain in order to benefit from a 10% discount on purchases made with this advance, and then entered one of the chain's stores to make a $10 merchandise purchase (at a cost of $9 after the 10% discount is applied, ignoring any taxes), the user's device may show a bar code that could be read by the merchant's bar code reader in order to indicate (again, either directly or indirectly) to the merchant that the user had prepaid $50, which is the present (initial) balance available under the terms of the deal, and that the user is further entitled to a 10% discount in conjunction with the use of these funds (the $50 or balance remaining, thereof). Once the $10 merchandise purchase is completed, for example, an embodiment of systems and methods of the invention may credit the merchant's account $9 (the net amount spent following application of the discount), debit the user's account $9, and provide feedback so that the user's mobile device now shows an available balance (for this merchant under and the specific terms of this particular deal) of $41. In another embodiment, instead of a bar code facilitating redemption and the transfer of information between a user (e.g., the user's device) and a merchant (e.g., the merchant's point-of-sale or other system), radiofrequency identification (RFID) technology or near-field communication (NFC) technology may also be used. In this case, at the time of the merchandise purchase the user may position their mobile device (or an associated RF identification tag) within range of a reader and, in response to such positioning, information may be transferred by means of the RFID or NFC technology. In other embodiments, other means of communication may be used to communicate (e.g., transfer) information between a user (or a user's mobile device) and a merchant (or a merchant's point-of-sale or other system) in order to facilitate a transaction. A transaction may include one or more of: debiting a user's account, crediting a business's account, updating a system (and associated database) that tracks users' deals and balances (and possibly other information), and providing data to a user's device so that a user may see in a deal visualization active deals and the balances or other information for each deal.

Operation 105 involves monitoring a deal (deal monitoring). Deal monitoring represents the tracking and collection of information (e.g., metrics) relating to deal presentation(s), deal opt-in(s), deal visualization(s), and deal redemption(s). Throughout the preceding operations 101-104, a large amount of data may be generated and collected. This data includes, for example, data representing user identities, user locations, user deal selections, user preferences, user deal views (of deal presentations), user deal visualizations, user redemptions (of deals), and more. In addition, a significant amount of data relating to the commercial offers and redemptions may also be collected, including the particular brands, stores, products and services involved. Data may also be collected from retail point-of-sale systems, credit card processing systems, and more, which may be integrated (via one or more networks, for example) and considered a part of embodiments of the invention. Such data may then be stored in one or more databases, which may take any of a variety of forms. The data may then also be analyzed in order to provide useful information to consumers (users) and businesses. Such analysis may provide information relating to spending patterns and habits, deal types, deal amounts, average and aggregate savings, the demographics of users, the demographics of users opting into a particular deal, the revenue generated by a particular user or deal, and much more. These metrics and analysis are potentially extremely valuable to various users of embodiments of the present invention.

Any subset of this information (or all of it) may be collected and shared. This may be done in a distributed manner, with elements of the entire data set being located on different databases, possibly associated with distinct systems, or in a centralized way with all information being sent to, and stored in, a single database (which may be shared, copied or backed up). In either case, the data may then be made available for presentation and analysis. Businesses offering promotions using the system may find such data and analysis valuable, including user and deal conversion rates and associated costs. Likewise, consumers may find certain data and analysis valuable, possibly including a user's average spending on deals (per period), total amount spent on deals to date, total savings over time, and more. Data and analysis may be provided for each individual user (consumer), each individual business (merchant), each individual deal (promotion), etc. Data and analysis may also be provided in the aggregate, meaning for all users, businesses or promotions, or for any subset of users, businesses or promotions that, for example, share one or more demographic or other features. Uniquely, embodiments of the invention may also be used to create valuable metadata, and data emerging from behavior over time. For example, a user's selection of specific deals may indicate a preference for a particular brand. Overall, the collection of data and facilitation of analysis of all types is valuable and benefits users and businesses, as well as any entity operating systems and methods of embodiments of the invention (in the latter case to improve sales or operations, for example).

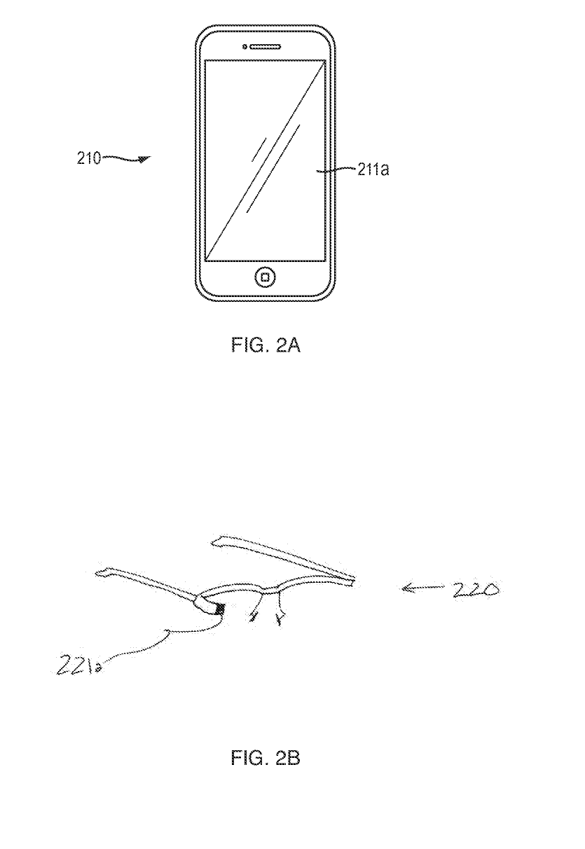

FIGS. 2A-2B show representative embodiments of portable devices that may be used in conjunction with systems and methods of the invention. FIG. 2A shows a embodiment of a mobile device (e.g., smart phone). Other such mobile devices and portable electronic devices, in general, may be used in conjunction with systems and methods of embodiments of the invention. FIG. 2B shows a Google Glass™-like device that empowers wireless communication, including a display that enables a user to see information directly adjacent the user's view of the real world beyond. Various portable wireless communication devices exist, and these are constantly involving and improving, including their forms, displays and output elements, along with their associated transmission and reception elements, wireless communication protocols, wearability and form factor, and more. Devices keep getting more powerful, as well as being able to communicate and process more information more quickly. Embodiments of the present invention may be used in conjunction with any such devices.

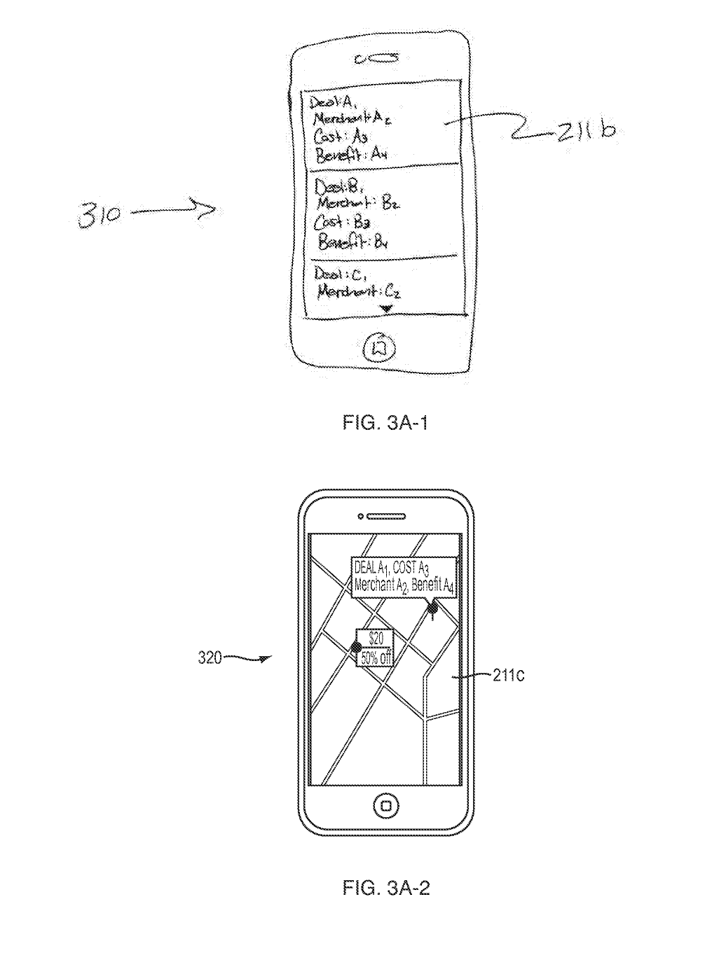

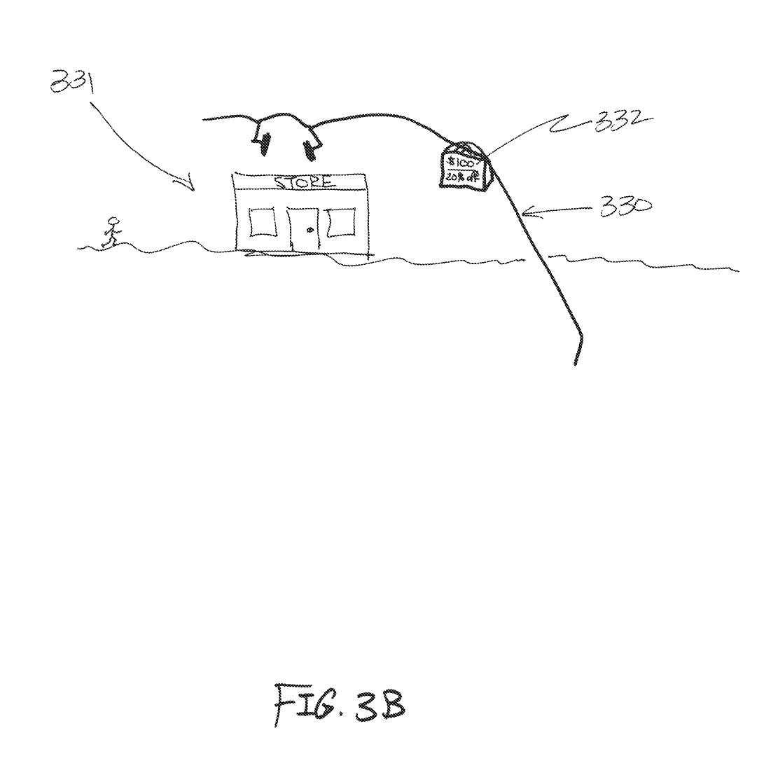

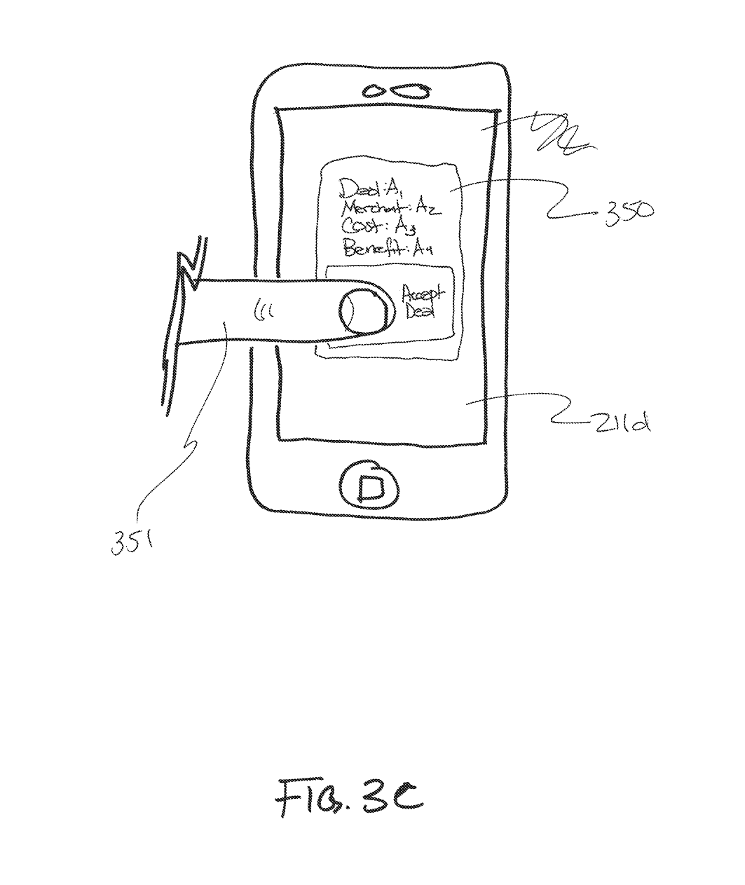

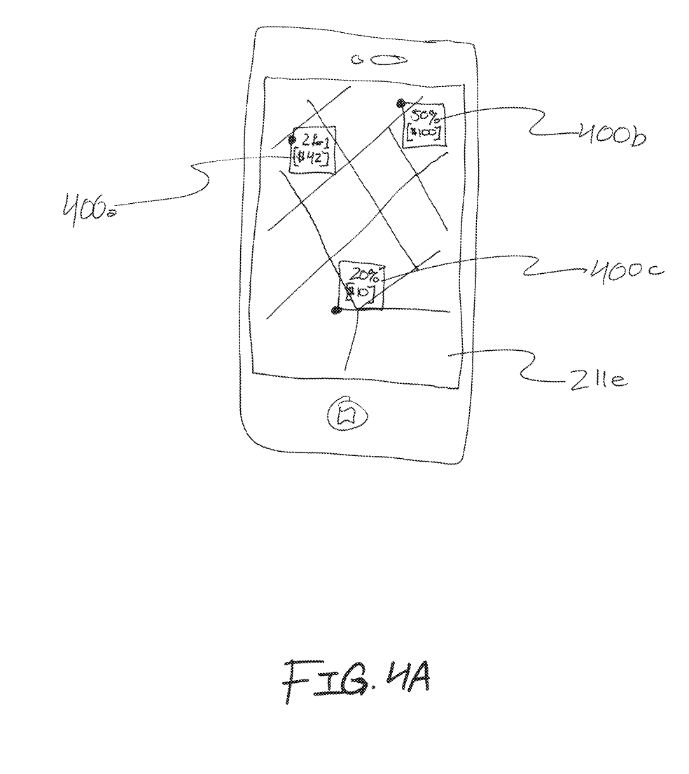

FIG. 3A-1 shows an embodiment of a portable wireless communication device (e.g., smart phone) showing deal presentations in list format. FIG. 3A-2 shows a similar embodiment of a portable wireless communication device with deal presentations shown in a geographic context, e.g., on a map. In this embodiment two promotions are shown, a first deal representation and a second deal representation. As noted previously, such deal representations may take any of a variety of forms. While each one is generally located at a place on a map associated with the location of the deal in real life, the representations may be, for example, pins, dots, brand-associated images (e.g., logos or photos for stores, product or services) or other graphics, and more. Alternative embodiments may include a bubble or other graphic containing more information (beyond the location of the deal which may be indicated by the position of the pin, dot, icon, image, etc. on the map), such as specific details about a deal (e.g., information relating to the cost and the benefit of the particular deal), an address, the names, usernames or associated graphics of others who have taken the deal, and more. As an alternative to such information appearing in a bubble on the map, the information may appear above, below or beside the map graphic, or may appear as a drawer (image that may be “pulled out” or exposed from the side of a display or frame, possibly by selection or other command of a user) or some other presentation. In addition, information may be represented to a user with words, graphics, voice output, sounds, and more. The goal of such output is, in this particular instance, to share information relating to deal presentation.

FIG. 3B shows an embodiment of deal presentation as it may appear looking next to the display of a Google Glass™-type device, where deal-related information appears adjacent to a user's view of the real world. In such an embodiment, a user may, for example, look at a retail store and concurrently see the deal presentation-associated information, such as the cost of the deal, and the benefit that the deal offers. As a user moves around and also looks around the real world, deal-related information may be presented as deal venues are being seen by a user in real time. Furthermore, embodiments of the invention may provide simple (unobtrusive) guidance that a deal may be found in a particular direction or place, and deal presentations may use images, symbols, graphics, etc. to represent deal characteristics while minimizing the amount of display space, intrusion and also distraction for a user. For example, in lieu of words, symbols may be used to represent various deal parameters, e.g., type of deal, cost and associated benefit. Such embodiments may work especially well in environments where standardization of deal terms is possible, e.g., a limited number of pre-purchase dollar amounts, possibly along with a limited number of discount possibilities or other standardized benefits or rewards.

FIG. 3C shows a user interacting with a wireless communication device in order to select a deal. In this drawing figure deal selection is being made by touching a deal presentation that appears on a touch-sensitive display of the device. As previously discussed, there are many other ways to opt-in, select and indicate a deal, or one's desire to engage with or accept a deal, beyond touching an interactive display. Other ways of opting into a deal include but are not limited to the use of human voice or sound, touching or physically interacting with a device, movement, or even gestures that are sensed by the device (or a sensor communicating with the device). In the future, technologies that perceive a person's decisions or intent may also be used as a way for embodiments of the invention to ascertain that a user desires to opt in to a deal.

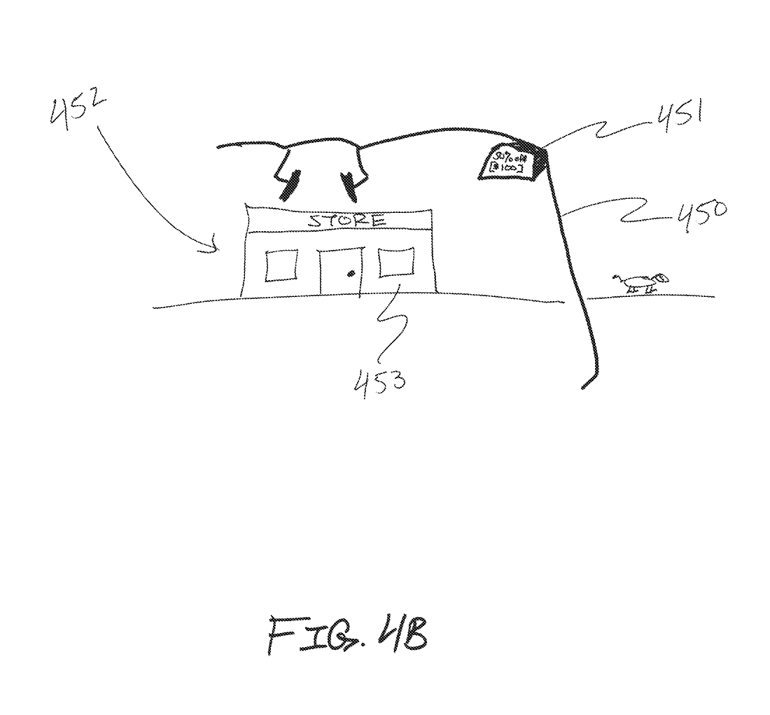

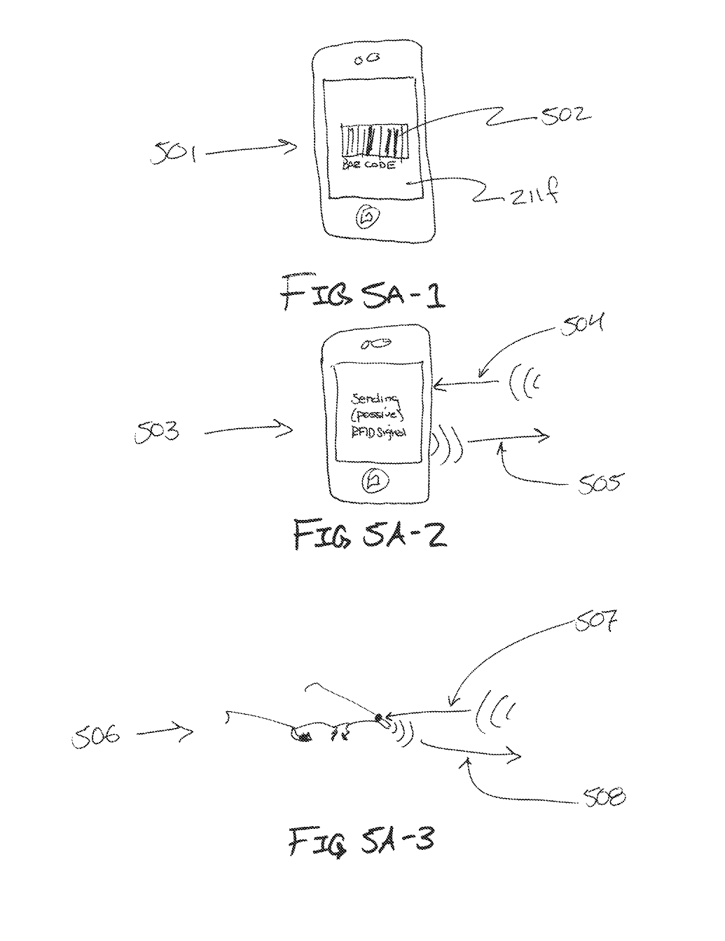

FIGS. 4A and 4B show embodiments of deal visualizations. These represent visual information that may be presented to a user once the user has selected one or more deals, and is now interacting with their device (and the world at large) and interested to discover the locations of deals that they have already selected. FIG. 4A shows a smart phone-type device displaying an orienting image (map) on its touch-screen display, and the map further showing, in this particular embodiment, a bubble superimposed on the map nearby the position on the map associated with the location of the deal (indeed, pointing to the represented location of the deal on the map in this case), the bubble containing deal-related information for the deal that the user has already selected, e.g., a discount (20%) and balance remaining ($50.00). Bubbles or alternative visual presentations may contain this information, or other deal-related information, and may be static or expandable, or contain links so that a user may access additional information, e.g., a list of friends who have also selected the deal. FIG. 4B shows an embodiment of a visualization of information relating to a previously-selected deal on a Google Glass™-like device. In this embodiment, as an example, a user sees a particular store, product or service (or something else that has a deal associated with it)—the orienting image, in this case—and concurrently sees information (that is co-presented) relating to the particular deal associated with the particular place or object that the user sees while wearing the device. Similar to deal presentation, there are several methods of representing deal-related information so that it is capable of being efficiently interpreted by a user, including using words, symbols, icons, logos, images, symbols, directions, arrows, graphics and more. Many other deal visualizations are possible and fall within the scope of embodiments of the invention.

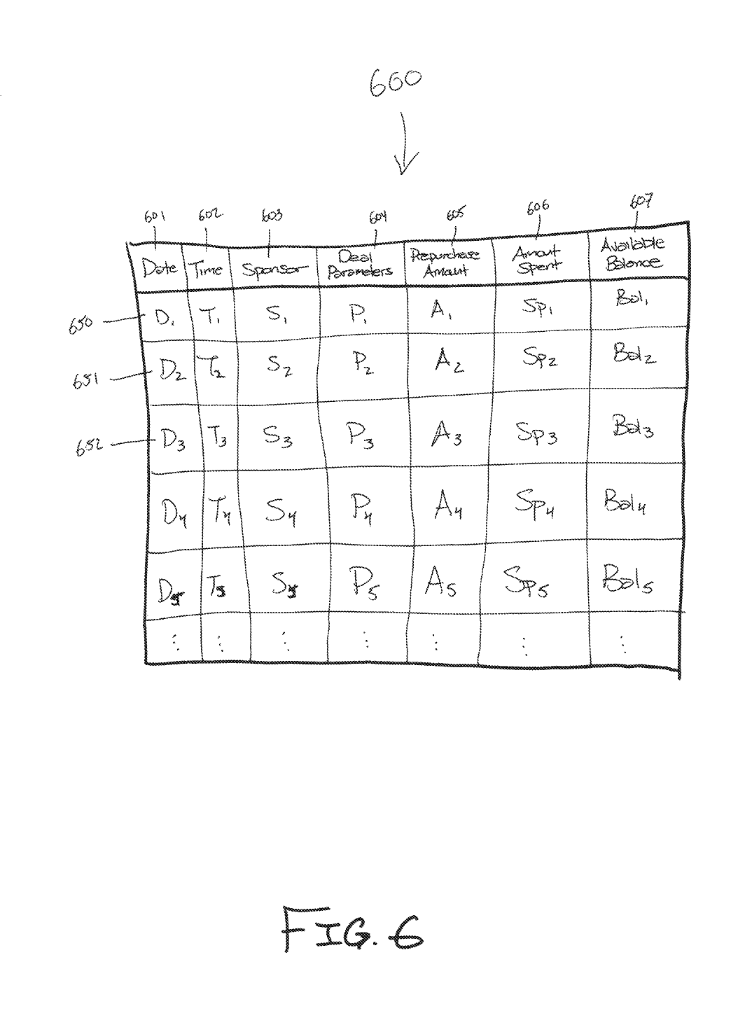

FIGS. 5A-1, 5A-2, and 5A-3 show representative embodiments of deal redemption elements of the invention. FIG. 5A-1 shows a representative bar code that is being displayed on an electronic display on a smart phone. Such a presentation may be scanned by a bar code reader owned or controlled by the business that is redeeming the deal, for example, and the information. FIG. 5A-2 shows another embodiment of a deal redemption element associated with a mobile device such as a smart phone. In this particular embodiment, a wireless signal facilitates the transfer of information that permits the deal to be redeemed. Such wireless communication may be performed using RFID technology, NFC technology or other wireless transmission means. In such a case, for example, data relating to the identification of the user (or the user's device), the applicable deal, and possible deal details and fund balance information, may be communicated between the mobile device and a system associated with a merchant's point of sale system or other business information system, or network, for example. Information may be ultimately stored and accessible on one or more databases, controlled by the merchant or the entity operating the deal system of the invention. FIG. 5A-3 represents a similar system and method of deal redemption as FIG. 5A-2, wherein a Google Glass™-type of wearable wireless information and communication device wirelessly communicates to share information about deal redemption for a particular deal-associated transaction, for example. While such wireless communication may use any of a variety of transmission and reception technologies (and also any of a range of frequencies and wireless communication protocols), one embodiment involves use of NFC technology to share information about the particular device and/or user, and possibly also information relating to a deal. Such information may be provided to the business's system either directly (fully by means of wireless communication between a merchant's system and the device), indirectly (such as when only an identifier is shared and then data is secured through a network from a database, relying on the identifier, for example) or some combination of direct and indirect methods. As wireless communication technologies evolve, other systems and methods may be readily applied to share data between a user's device and a system owned or controlled by a merchant or business in order to facilitate sharing of data to facilitate deal redemption. Deal redemption may be facilitate by other means, such as a wearable RFID bracelet or tag, or multiple identification elements (that may be detected and analyzed in combination) for the purposes of validating the identity of a user and enabling or otherwise facilitating redemption of a deal or related interaction or transaction.

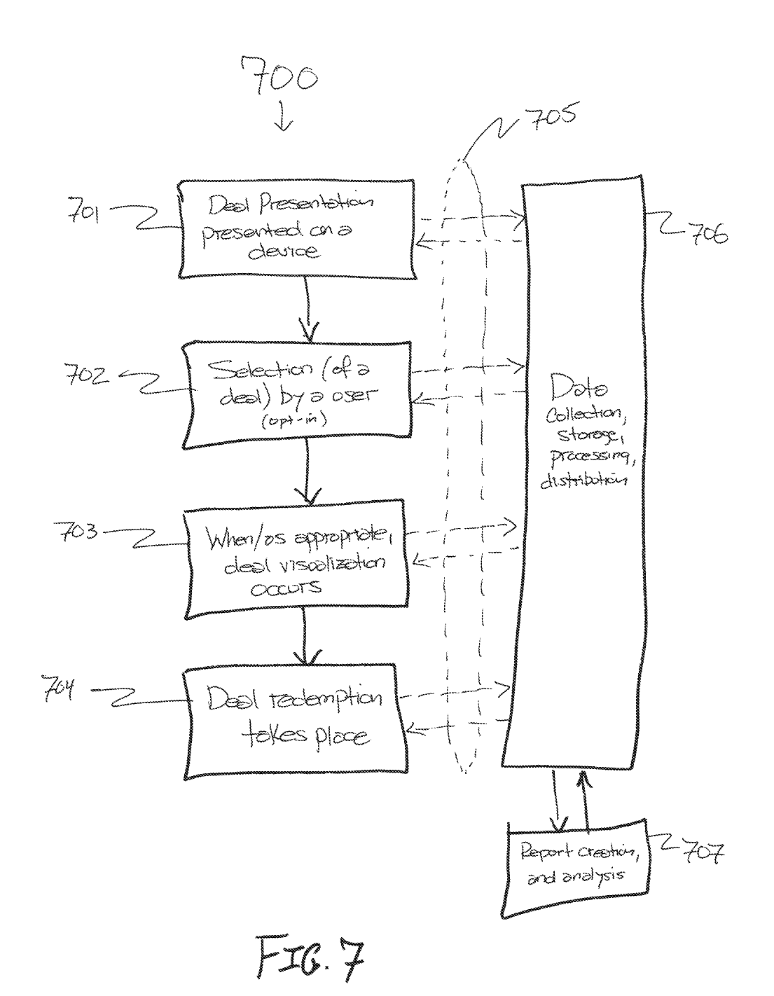

FIG. 6 shows a list of data elements that may be collected by systems and methods of embodiments of the invention. These data elements may be used, for example, to create a database information structure (e.g., data fields). As another example, these data elements may be used to generate a display of the data for each of the elements, e.g., creation of a report or dashboard that may be used by users of the invention. The data elements listed in FIG. 6 are only meant to be representative of data that may be collected, communicated (e.g., over a network), stored, retrieved, modified and analyzed. Many other data elements may be produced or producible by embodiments of the invention and its use, and any one or more of these may be used to inform the creation of a database of the invention, reports or other presentations of the data, and associated analyses. The data elements shown in FIG. 6 are: Date, Time, User (e.g., user ID), Sponsor (of a deal), Deal Parameters, Prepurchase Amount, Amount Spent, Available Balance. Data sets may, of course, include this or any of a wide range of other data.

FIG. 7 shows a representation of one embodiment of a method 700 of the invention. In this embodiment, deal presentation 701 is performed on a device, such as a smart phone or Google Glass™-type device. After deal presentation, the device receives input (e.g., from a user) 702 to thereby indicate the selection (or opting in) of the user to a specific deal. Following this, and when the circumstances are appropriate (e.g., the user is in the vicinity of a deal's location and is viewing a map that includes the location), a deal visualization occurs 703 whereby the user may be alerted to a previously selected deal and/or be provided with deal-related information. At some point, such as at the time of or after deal visualization, a user may use their device (or other means for user identification or identity validation) to redeem a previously selected deal 704. An example of this is to apply all or part of an available credit of funds toward the purchase of a product or service, at a discount. After a deal is visualized it may be redeemed 705. Throughout this process, data is transferred 706 to a database, which may be either centralized or distributed. Data transfer may occur over one or more networks, each network being either wired or wireless. Finally, at any time that data is available, the data may be used to generate a report or perform an analysis 707.

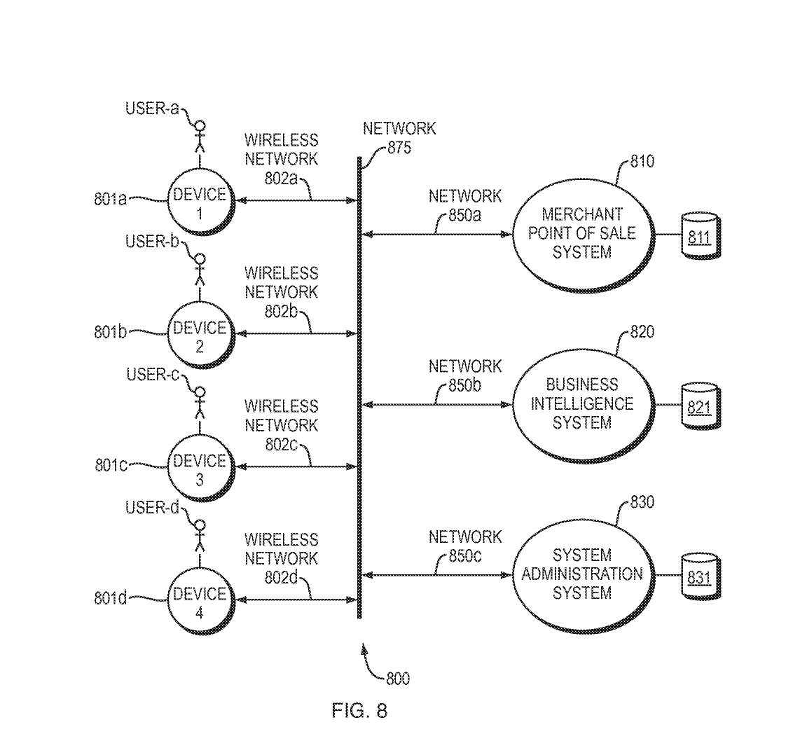

FIG. 8 shows a representation of an embodiment of one system 800 of the invention. In this embodiment, the system 800 includes four unique communication devices 801a-d that are wirelessly networked, using a network 802 with three other possible system elements: a merchant point-of-sale system 803 that at least may facilitate deal redemption, a business intelligence element 804 that enables collection of data generated by other elements of the system, and an administrative element 805 that enables a degree of control of the other elements of the system. Each of the latter system elements may further be associated with a database 806a-c. Other systems and system elements are possible and fall within the scope of embodiments of the present invention.

In addition to the embodiments of systems and methods of the invention already described, embodiments of the invention may include other elements.

For example, deal presentations may include associated parameters relating to the way a deal presentation is distributed. As on example of this, a deal presentation may only be distributed (and therefor presented) on the devices of users satisfying certain demographic criteria. Such demographic criteria may include, for example, criteria based on a user's age, gender, socioeconomic status, brand preferences, prior selections, social network, affiliations, location, and more. As another example, deal presentation distribution may be limited according to time or duration, e.g., a deal may only be valid and also presented prior to a specified date and time.

As another example, systems and methods of embodiments of the present invention may include security means. For example, prior to the selection of a deal, the identity of a user may be validated using any of a variety of identity validation means. Such identity validation means may relate to the input of a code (by a user) to a user's device, or the detection by a device of a proprietary action (e.g., a gesture or vocal output that is sufficiently unique to the user). This may be important, for example, during opt-in for a deal requiring precommitment of money or other valuable consideration, such as the charging (debiting) of a user's credit or debit card to cause such a deal to then be redeemable. Other means for establishing the identification of a user, within a given probability, or otherwise assuring the security of an action or transaction are possible and anticipated.

As wireless communication devices are evolving rapidly, including a possible shift from handheld to wearable devices, it is notable that the systems and methods of embodiments of the invention may be implemented by any of a wide range of devices, provided that they have (or are connected or networked with elements that provide) some form of input means, such as a touch-sensitive display, user-selectable hard or soft keys or buttons, a microphone to sense sound, or other sensors. Similarly, these devices may include elements which enable communication back to the user, such as visual displays that emit, project, show, impute or otherwise produce visually perceivable signals that may be seen or perceived by a human user. While this includes current smart phones and wearable type devices (e.g., Google Glass), other devices are possible and fall within the scope of the present invention, including multiple networked wearable devices.

Embodiments of the present invention include a device that enables a user to view one or more brand identifying images, such as one or more logos, on a display, and to select a particular brand identifying image using input means to thereby enable the presentation of a map image indicating a current location of the device and showing the locations of any one or more brand access sites for the selected brand that are located in proximity to the user (i.e., within the geographic area presented on the map). The system benefits users, for example, by facilitating the location and purchase of brands of products and services selected by the user by automatically directing (i.e., independently of location-specifying information provided by the user) the user to a nearby location where the selected brand of products or services may be available for purchase.

A “brand” is defined as a distinctive identity of a collection of related products or services. A “branded entity” of a particular brand is defined as a product or service having the particular brand. For example, a bottle of a Coca-Cola brand soft drink is an example of a “branded entity” of the Coca-Cola brand of soft drinks. A “brand access site” for a particular brand is defined as a location at which one or more branded entities of the particular brand may be accessed.

In general, as used herein, branded entities of a brand may be accessed (e.g., purchased) by a consumer at one or more brand access sites. In some instances, for example, a brand of products is marketed or sold under a common trademark. In other instances, for example, a brand of services is marketed or sold under a common servicemark. One example of a brand of products is the Coca-Cola brand of beverages. Another example of a brand of products is the iPod brand of consumer electronics. Yet another example of a brand of services is the Jiffy Lube brand of oil change services. Yet another example of a brand of services is the H&R Block brand of tax preparation services.

In addition to anything that comes under the definition of a “brand,” embodiments of the present invention may also be used in connection with any of a wide variety of non-brand representations on a map, meaning the locations of non-brand points of interest that appear at a position on a map corresponding (or substantially corresponding) to their actual (i.e., real-world) location. These non-brand points of interest may include, for example, non-branded parking areas, non-branded parks and recreation areas, non-branded public services. The term “branded entity,” as used herein, includes both entities having a brand and entities not having any brand. In addition, aggregations of branded entities and non-branded entities (products, services and more than may be represented on a map, for example) may be represented in the aggregate, including as categories, e.g., a restaurant icon that may represent more than one branded entity and/or non-branded entity, or some combination of these.

A prompt may be anything displayed or otherwise output by a mobile device (or associated device or accessory) that entices a user to select it or otherwise indicate an interest to learn more, or specifically to view the map. There are many different types of prompt that are possible, and that can achieve this. As one example, a prompt may resemble (or be) a mobile banner advertisement. Such an advertisement may include words, images, graphics, symbols, and more, and may be complemented (or introduced) by sound, movement or vibration produced by the device. An example of a banner advertisement with a word may be a simple as “Hungry?” which might entice a user to select it to see the map and learn where the nearby restaurants or grocery stores are located. Another embodiment of a banner advertisement might include the simple question “Hungry?” and also display one or more (static, dynamic or rotating) logos of restaurants (either generally, or nearby restaurants, e.g., those that would appear on the map), to entice a user to select it. In one embodiment of the present invention, a prompt is served to a device and then displayed on the device based on a determination that a trigger condition has been satisfied. Such a trigger condition may be that a minimum number of brands will be represented on the map that a user would see if the user selected the prompt. As another example, a trigger condition may be that the proximity of a particular brand, such as a brand known (or expected) to be liked or preferred by a user of the device, falls under a certain maximum proximity. As yet another example, a trigger condition may be that the proximity of one or more brands that are known to be used or preferred by one or more members of a social network that includes the user of the device, falls under a certain maximum proximity. It should be noted that various assumptions about a user of a device are based on characteristics of the hardware and software of the device, applications installed on the device, data stored on or transferred (sent or received) by the device, and more. Based on this, references may be made to a user (and should be interpreted as probabilities based on the aforementioned characteristics of the device and related data and communications).

Prompts may take any of a variety of forms and formats. As noted, a prompt may be or resemble a mobile banner ad (advertisement). Many other forms and formats of prompts are possible, including those that include images, video, sound, or movement, or some combination of two or more of these. In one embodiment of a prompt, it may appear as a “drawer” that may be selectively pulled out from a margin of a displayed image or page (such as a game app image, or social network app page). A tab associated with the drawer, such tab which may always be present or only displayed under certain circumstances (such as following a trigger as described above), may be selected to “roll out” and display the map to a user. When a user so desires, the drawer may be replaced and moved out of the way, back into its original position as an unobtrusive tab, for example. Such a drawer may be located to appear (open up) from the top of a display, bottom of a display, side of a display, or middle of a display. In this last case, a “drawer” may open up from a prompt located within a page or image showing on the display to show the map. A wide range of embodiments of prompts are possible, from those looking like typical banner ads, to small images or logos appearing within text, to symbols representing the presence of drawers. In certain embodiments of the present invention, a prompt is unobtrusive. In other embodiments of the present invention, a prompt empowers a user to determine when and where the user desires to see the map.

A prompt may be selected in any of a variety of ways. In one embodiment, a prompt is selected by a user physically interacting with a device. As one example, such interaction may be use of a user's finger to touch the prompt that appears on a touch-sensitive display. This is one way that a user may indicate a selection of a prompt, such selection which may be sensed or otherwise detected by an element (e.g., touch-sensitive display, key or button) of the device. As two other examples, a user could use a voice command or sound to indicate a selection of a prompt. As another example, a user could use a movement (such as a movement of the device) to indicate selection of a prompt. As yet another example, a user could use a gesture, such gesture detectable by the device (or another device networked with the device), in order to indicate selection of a prompt. In an embodiment of the present invention, indication of a selection of a prompt displays the map.

Embodiments of the present invention involve determining that a device has been relocated to a brand access site. This is expected to correlate with the movement of a user to a location in proximity to a brand access site. This may be important in order to determine if a prompt, possibly in combination with a map (and associated images), is working in terms of effectiveness for a sponsor, e.g., an entity that may be paying for the prompt or map or images appearing on the map. One meaning of the phrase “relocation of the device to a brand access site” is locating the device at a position in space that is in proximity (possibly within) a brand access site, such as a store, shelf, or other location where a branded product or service may be found, or where a non-brand product or service may be found. In addition to determining that a device is in or near a brand access site, embodiments of the present invention may also determine that a device is moving toward a particular brand access site. Such a determination may enable a merchant to anticipate and prepare for a relocation (e.g., visit) by a customer or prospective customer. This may be especially valuable in the case of a prepurchase, such as when a user uses the device to prepurchase a product or service prior to moving to a location (relocating) in proximity to the brand access site. An example of this is presenting a user with a prompt enticing the user of a mobile device to view a map on the mobile device, the map showing (among other things) the location of a branded service such as a movie, then enabling the prepurchase of a ticket to the movie and determining that the user (by detecting the movement of the user's device) is on the way to the movie theater (the brand access site).

There are several ways to determine that the device has been relocated by detecting its location (or change in location, or expected position). In one embodiment, a location-determining element of the device itself (e.g., an IP-address-driven location component and/or a global positioning system (GPS) component) may determine the current location of the device and communicate this information, or simply communicate a confirmation that the device has arrived at (or is in the vicinity of) the brand access site—or that the device is moving toward the brand access site, or expected to be at the brand access site, perhaps at an expected time. In another embodiment of the present invention, the relocation of the device may be determined by means external to the device, such as cell-tower based localization, near-field communication (NFC) or radiofrequency identification (RFID) interactions with a receiver or reader. As yet another example, the fact that the device has relocated to or near a brand access site is by using input to the device (or to another device) by a user. The user may be the user of the device, or someone else who indicates the arrival of the user of the device at the brand access site. As mentioned, such arrival at or near the brand access site may also be accomplished by identifying a user's presence at the brand access site, such as by means of NFC or RFID technology.

Embodiments of the present invention may be used to enable, implement, conduct, execute, facilitate, and/or complete a transaction. An example of a transaction is a purchase, such as a purchase of a product or service. Another example of a transaction is the application of some currency, such as points or another form of virtual currency, in exchange for a product or service or other benefit or things of value. Transactions may be enabled by embodiments of the present invention in any of a variety of ways, including using systems and methods that are already known and used for such purposes. In one embodiment, a near-field communication (NFC) technology may be used to cause or facilitate communication between a device and a merchant's point-of-sale system in order to enable a transaction. Such enablement may include transfer of a device or device user identification number or other identifier, transfer of security information to validate the device, user or transaction, and more. Other technology, such as radio-frequency identification technology (RFID) of both passive and active types, may also be used by embodiments of the present invention to enable or facilitate a transaction. In yet another embodiment, a transaction may be enabled or facilitated by means of the device display presenting a bar code that is readable by a merchant's bar code reader, which may be connected to a merchant point-of-sale system, for example. Other systems and methods may be used to enable or facilitate a transaction and are consistent with, and anticipated by, the present invention.

Following completion of a transaction (or even during the enablement or facilitation of a transaction), in embodiments that use the device for at least some aspects of transaction enablement or facilitation, the device may include or otherwise have access to data (and “know”) that a transaction has taken place (and possibly also that a transaction has been initiated, is in process, or has been canceled). The device may sense or detect information relating to a transaction by means of being engaged in enablement or facilitation of the transaction, algorithms that run in order to detect a transaction or determine that a transaction has taken place (and to learn its details), and/or by other means. Information relating to a transaction may be communicated by the device to other elements of embodiments of systems of the present invention, such as to a processor or a database (where the information may be stored and also retrieved, for example). The information may then be made available for analysis, creation of reports, and presentation to users on their devices, or otherwise. One particular valuable use of information relating to a transaction is to learn (by means of an analysis) whether a particular prompt or other detail relating to a prompt (e.g., when it is served, where it is served, the person or demographic of the person it is served to, how it is displayed) is effective in terms of certain objectives. One possible objective is providing relevant information to a user. Another possible objective is providing valuable information to a user. Another possible objective is enabling a sponsor of a prompt (e.g., a merchant who is paying for the prompt) to determine whether or not the particular prompt (or the way it was served) has been effective, such as from an economic, revenue or earnings perspective.

Information and data generated by embodiments of the present invention, including but not limited to information and data relating to the determination of relocation (or location) of the device (to a location within or in proximity to a brand access site), as well as information and data relating to a transaction, may be shared with other systems of embodiments of the present invention or external to such systems. Such sharing may be done by means of a communication network and standard protocols, for example. In one embodiment of the present invention, such communication may be done using a wired network. In another embodiment of the present invention, such communication may be performed using a wireless network. In yet another embodiment, both wired and wireless networks are employed to share or otherwise communicate such information and data among and between devices and systems associated with the present invention. An example of such an associated system is a merchant's point-of-sale system, integration with which could enable transactions, determination that such transactions have been made, communication of such determination, and more. In addition, a system such as a merchant's point-of-sale system may also sense the presence of a user or a user's device, enabling a determination of relocation of a user to a particular brand access site, for example. Again, such a system may also communicate this information. The acquisition and communication of this information is valuable to businesses in order to determine, among other things, the effectiveness of mobile advertising strategies, specific advertisements and campaigns. In addition, the acquisition and communication of this information enables the provision of value to users (consumers) in order to optimize their mobile experience, provide customization and personalization, determine which prompts, brands, maps and ads are of most relevance to any particular user, provide valuable data and feedback to a user, and more. For example, both businesses and users may derive value from an understanding of an individual user's (or group or segment of multiple users') behaviors, preferences, actions, spending habits, purchases, trends, movements and more. While privacy concerns prevail, such information might be shared with businesses in aggregate, while individual users receive access to their personal data, for example. Beyond the raw data, such data may be used by embodiments of systems and methods of the present invention to perform useful analysis and generate reports. In one embodiment of a report, information (e.g., information about a user's behavior or past purchases) may appear as words, symbols or images on a user's map. Such information would be updated, as the underlying data changes, over time. Also, alerts or various signals may be sent to a user based on such information.

One embodiment of a method of the present invention include determining that the device has relocated to a location within or in proximity to the first brand access site (or that the user has accessed the first brand) and also determining that a transaction relating to the first brand (or relating to the first brand access site) has occurred. In another embodiment of a method of the present invention, only a determination that the device has relocated to a location in proximity to the first brand access site (or that the user has accessed the first brand) is made. In yet another embodiment of a method of the present invention, only a determination that a transaction relating to the first brand (or relating to the first brand access site) has occurred. In any of these three embodiments, the information secured through any determination may be useful and valuable to a sponsor of a prompt, user of a device (e.g., consumer), and others.

All humans have preferences, and embodiments of the present invention enable determination of a user's preferences. This may be done in order to provide a relevant service to users, as well as to provide businesses with a better understanding of the preferences of users (whether or not a user or group of users prefers the business's particular brand or brands). In one embodiment of the present invention, a user may indicate one or more preferences. Such indication may occur by means of the user's interaction with a device. For example, a user may have previously selected certain prompts, which may indicate a preference for specific brands, activities, locations, etc. In another example, a user may be asked questions, or may fill out a survey, to indicate preferences. In yet another example, systems and methods of the present invention may determine and track a user's map views, purchases, movements, selections, and more, either alone or in some combination, in order to determine a user's preferences. In yet another example, a third party (e.g., survey firm, merchant, credit card company) may provide data about the preferences of an individual user, or preferences of multiple users sharing one or more demographics or characteristics, for example. All such determinations about preferences may then be applied to serve prompts that are most relevant to a user, display prompts that are most likely to be selected by a user, customize a map presentation to be most engaging to a user (possibly including a determination of which brands, and how many brands, should appear on that particular user's map), and more, for example. As previously described, this (and other) information and data may be communicated between elements of embodiments of systems and methods of the present invention by means of a network, for example.

Embodiment of the present invention may be implemented using wearable wireless communication devices. Wearable devices include, but are not limited to, headsets (e.g., Google Glass™), wrist-worn devices, and devices that combine multiple elements to provide a user with a complete device. In the case of embodiments of the present invention that relate to headsets, various forms of a visualization are possible. In one embodiment, a visualization may be displayed on a small screen (the small size being relative to the screen size for a current smart phone device) that may be either within or near the straight-on field of view of a user. For example, such a display may be within the line-of-sight of a user when the user is looking straight ahead, either for one or both eyes. As another example, a display may be accessible and adjacent to a straight-on field of view, meaning that a user may need to look up and to the right to seek the display (and information that appears in the display), for example.

In an embodiment that includes a headset, due to the small size of the display and possible limitations on the amount of information that may be shown in the display, embodiments of the present invention may accommodate such a display and any limitations it may have. For example, rather than showing a map that shows the locations of nearby brand access sites, such a display may show a user brand-associated images (e.g., logos) for brands, along with an arrow or other symbol that represents a general location (e.g., direction to) an associated brand access site (or multiple directions to multiple nearby brand access sites). In such an embodiment, the information is displayed in a form that his maximal value for its size. In the case that there are multiple nearby brand access sites, an embodiment of the present invention that includes a headset-type device with a small display may rotate or otherwise dynamically change the presentation. For example, a first logo and first arrow (together indicating the direction of a location for a first brand access site for the brand associated with the first logo) may appear in the display, followed by a second presentation of a second logo and second arrow (together indication the direction of a location for a second brand access site for the brand associated with the second logo). In addition to display of images like brand-associated images, logos and arrows, other information may be presented. This other information may include words, images, symbols, and more, that represent a user's prior interaction with a brand or brand access site, a user's friend's interaction with a brand or brand access site (by means of integration with a social network used by the user of the device, for example), an indication of a deal or promotion at the brand access site (possibly including basic or detailed information about the deal or promotion), details about the brand access site itself (such as an address or phone number), and more. In addition, embodiments of the present invention may display information, and may also emit sound, voice or other output to provide user with information relating to a brand or brand access site. Furthermore, a headset or other wearable device may enable user interaction with the device by touch, spoken work, sound, movement, bodily gestures, and more, each of which would be sensed by the device using input means appropriate for the type of input, e.g., a camera for visual input, a speaker for sound input, an accelerometer for movement input, etc.

Embodiments of a wearable device of the present invention may enable any one or more of the following: presenting a brand-associated image; presenting brand-related information; presenting a prompt; receiving input from a user indicating the selection of a prompt; self-localizing without receiving user input about the location of the device; presenting information that directs a user to a brand access site; determining that the device is in proximity to a brand access site; facilitating a transaction, such as a purchase; determining that a transaction relating to a brand or brand access site has been completed; communicating data and information relating to any of these elements of an embodiment of the present invention, such as by means of a network, in order to enable the collection, storage, retrieval, dissemination, analysis and presentation of the information or data. Embodiments of the present invention include embodiments that make use of all of these steps, or some of these steps in any of a variety of sequences and combinations.

Embodiments of the present invention may also means for a user to engage in a deal involving an interaction (e.g., deal redemption) at a brand access site, wherein the deal is then represented on a map displayed on the user's device (using words or symbols, for example), the user's relocation to the brand access site and completion of the transaction detected by a system and methods of the present invention.

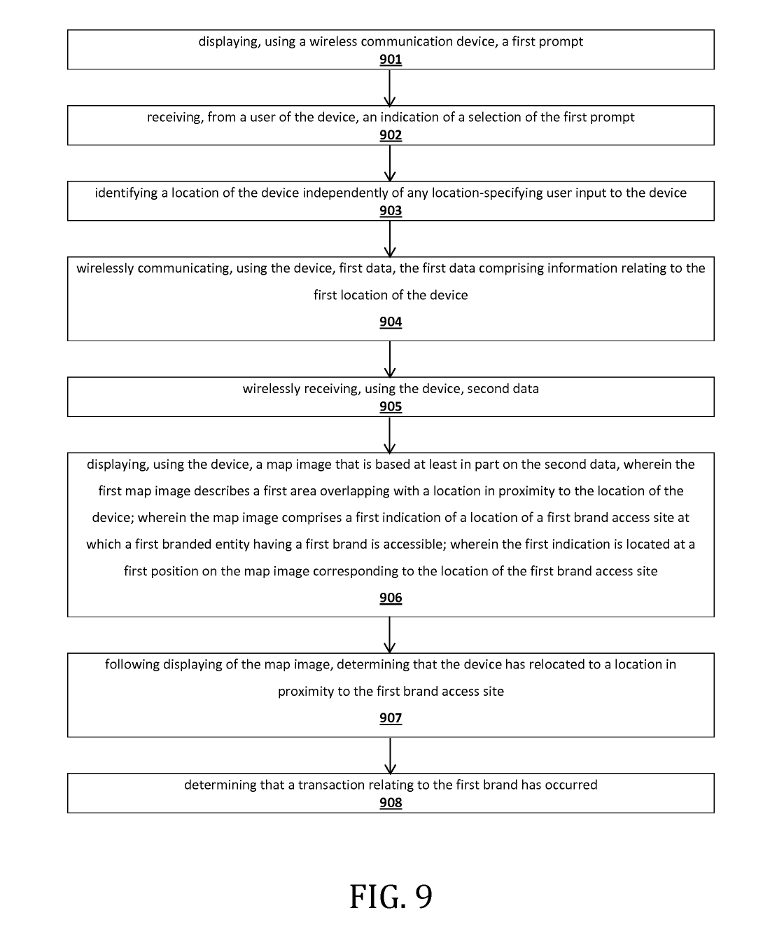

FIG. 9 is a flowchart of a method performed according to one embodiment of the present invention. The operations of this method will now be described. The wireless communication device displays a first prompt 901. Next, an indication of a selection of the first prompt is received by the device 902, as may be input by a user of the device, for example. The device location is identified in a manner independent of any location-specifying user input to the device 903. The device wirelessly communicates first data relating to the first location of the device 904. The device wirelessly receives second data 905. The device displays a map image that is based at least in part on the second data 906. In this embodiment, the map describes a first area overlapping with a location in proximity to the location of the device and the map further includes a first indication of a location of a first brand access site at which a first brand is accessible, and wherein the first indication is located at a first position on the map image corresponding to the location of the first brand access site. Following display of the map image, the embodiment of the present invention determines that the device has relocated to a location that is within or in proximity to the first brand access site 907. As another operation in this embodiment, the method determines that a transaction relating to the first brand has occurred 908. Other operations may be added to the method of FIG. 9. In another embodiment, for example, the device may be used to enable or otherwise facilitate a transaction. An example of a transaction is a purchase of a product or service, and more specifically a product or service of the brand of interest that is available at the brand access site, such as a brand associated with the first prompt.

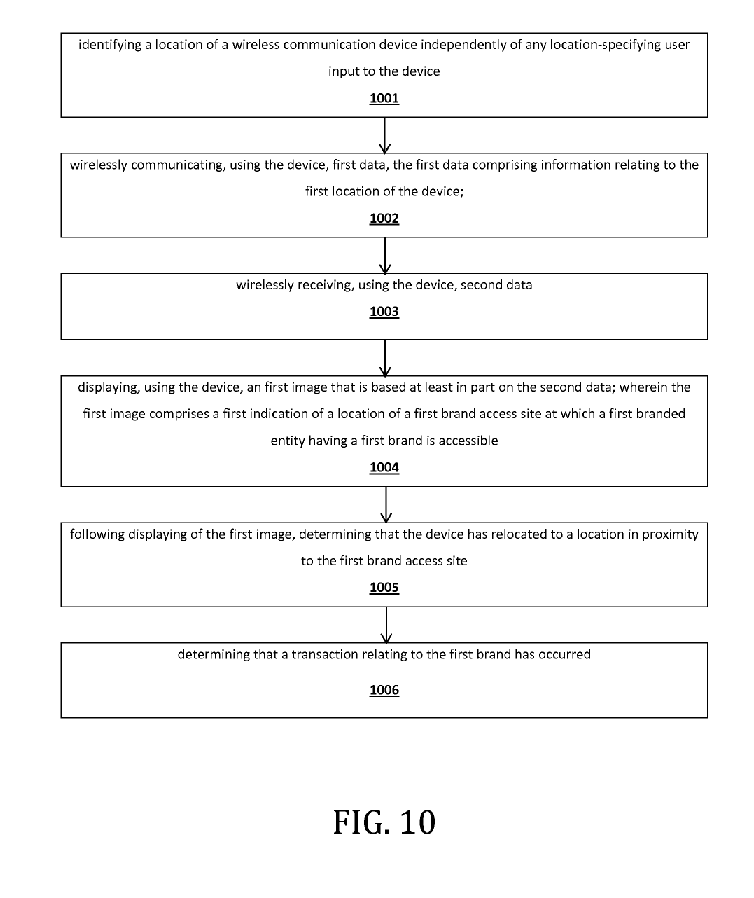

FIG. 10 is a flowchart of a method performed according to another embodiment of the present invention. The operations of this method will now be described. The device location is identified independent of any location-specifying user input to the device 1001. The device is used to wirelessly communicate first data that includes information relating to the first location of the device 1002. The device is used to receive second data 1003. The device displays a first image that is based at least in part on the second data, and wherein the first image indicates a first location of a first brand access site at which a first branded entity having a first brand is accessible 1004. At a time after the display of the first image determining that the device has relocated to a location in proximity to the first brand access site 1005. In embodiments of the present invention, determining that a transaction relating to the first brand has occurred 1006. The determination relating to the relocation of the device and the determination relating to the transaction may be the same or different. In other embodiments of the present invention the determination relation to the transaction may relate to the first brand or the first brand access site. As previously noted, a transaction may be a purchase. A transaction may also take any of a variety of other forms of interaction, including but not limited to some form of precommitment to purchase or use a product or service, or a social interaction.

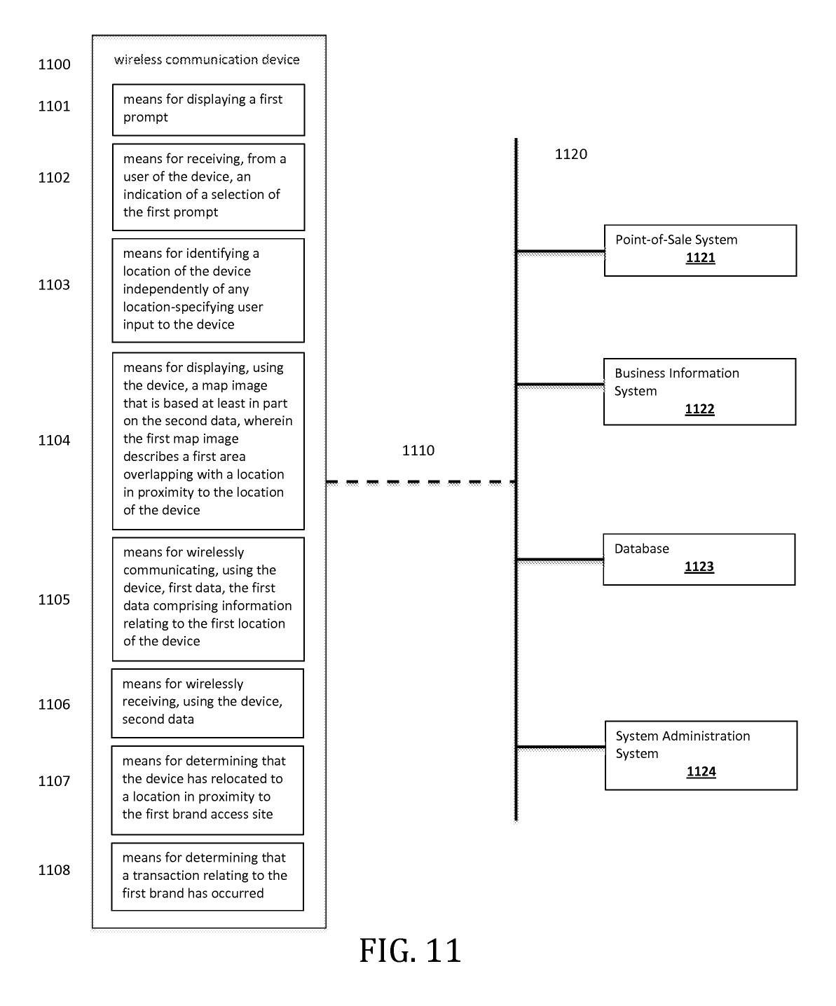

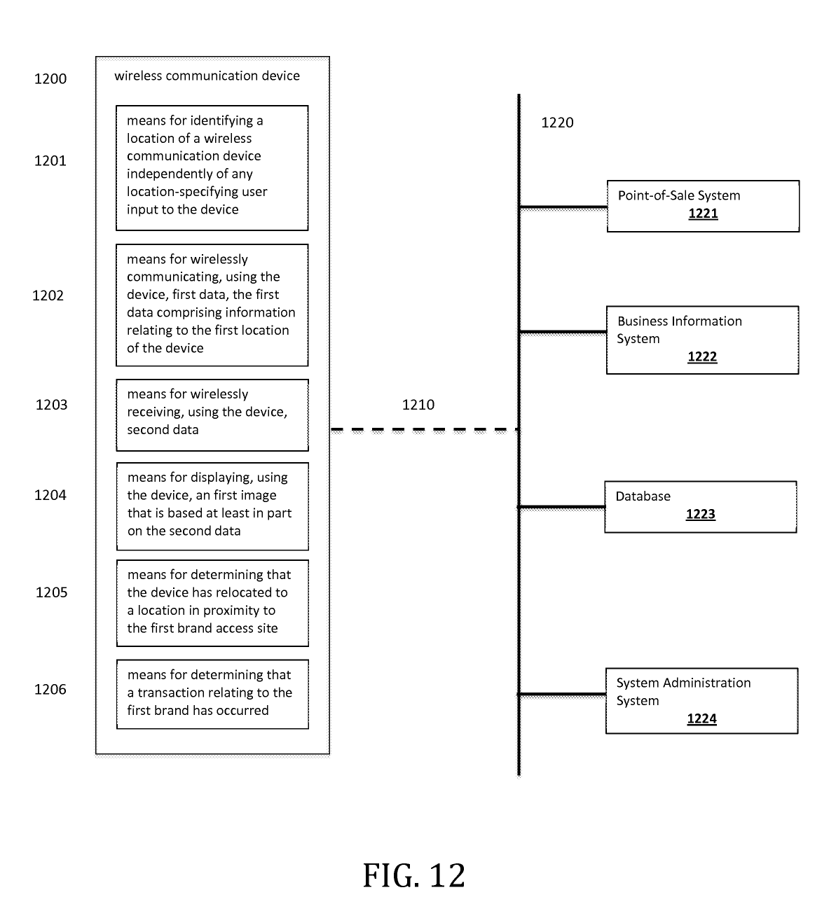

FIG. 11 is a representation of an embodiment of a system of the present invention. It shows a representation of an embodiment of a wireless communication device 1101, which further includes means 1102-1108, which will be described. Means for displaying a first prompt 1102, which may be or include a visual output or display (such as may be found on an iPhone™ or Google Glass™ or similar devices), for example. Means for receiving an indication of a selection of the first prompt 1102, which may be a touch-sensitive display, a keypad, or other input means (including but not limited to input means for voice, sound, motion and more). Means for identifying a location of the device without the user having to provide input that specifies the location 1103, which may be any of a wide range of device localization technologies (including but not limited to GPS-type means, IP address locating means, NFC, RFID, and other technologies, which may be located at the device, or off the device whereby the device location may be communicated to the device). Means for displaying a map image in a manner that corresponds to the location of the device 1104, which may be achieved by means of integration with a mapping service (e.g., Google Maps and its application programming interface, or API) to enable a map presentation that may be presented on a display of the device. Means for wirelessly communicating (e.g., transmitting) first data 1105 and means for wirelessly receiving second data 1106, which may in one embodiment be the wireless communication device's wireless transmission and reception means, respectively. Other embodiments of the present invention may use other types of communication technology, such as device-associated NFC or RFID means. Means for determining that the device has relocated to a location in proximity to the first brand access site 1107, which may be the device's location identification means as previously described, for example, or other location identification means. In some embodiments of the present invention, such means may include a merchant's point-of-sale system, which could detect the presence of a user at a specific location. Means for determining that a transaction relating to the first brand has occurred 1108. This means may be the same or different from the means that determines that the device has relocated to a location in proximity to a brand access site, which may be a store, shelf location, or another location more specifically or broadly defined. The embodiment of a system of the present invention shown in FIG. 11 also shows a representation of a wireless network connection 1110, other network 1120, point-of-sale system 1121, business information system 1122, database 1123, and system administration system 1124.

FIG. 12 is a representation of another embodiment of a system of the present invention. It shows a representation of an embodiment of a wireless communication device 1201, which further includes means 1202-1206, which will be described. Means for identifying a location of the device without the user having to provide input that specifies the location 1202, which may be any of a wide range of device localization technologies (including but not limited to GPS-type means, IP address locating means, NFC, RFID, and other technologies, which may be located at the device, or off the device whereby the device location may be communicated to the device). Means for wirelessly communicating (transmitting) first data 1203 and means for wirelessly receiving second data 1203, which may in one embodiment be the wireless communication device's wireless transmission and reception means, respectively. Other embodiments of the present invention may use other types of communication technology, such as device-associated NFC or RFID means. Means for displaying a first image based at least in part on the second data 1204. Means for determining that the device has relocated to a location in proximity to the first brand access site 1205, which may be the device's location identification means as previously described, for example, or other location identification means. In some embodiments of the present invention, such means may include a merchant's point-of-sale system, which could detect the presence of a user at a specific location. Means for determining that a transaction relating to the first brand has occurred 1206. This means may be the same or different from the means that determines that the device has relocated to a location in proximity to a brand access site, which may be a store, shelf location, or another location more specifically or broadly defined. The embodiment of a system of the present invention shown in FIG. 12 also shows a representation of a wireless network connection 1210, other network 1220, point-of-sale system 1221, business information system 1222, database 1223, and system administration system 1224.

It is to be understood that although the invention has been described above in terms of particular embodiments, the foregoing embodiments are provided as illustrative only, and do not limit or define the scope of the invention. Many other embodiments, including but not limited to the following, are also within the scope of the claims. For example, elements and components described herein may be further divided into additional components or joined together to form fewer components for performing the same functions. For example, in certain embodiments of the present invention, identifying a location of the device may be performed independently of any location-specifying user input to the device; however, in other embodiments of the present invention identifying a location of the device may rely on user input, possibly including location-identifying information. Furthermore, while some embodiments of the present invention will use a map to show the location of brand access sites and possibly related information, in other embodiments of the present invention other means will be used to show a user the location of a brand access site such as the display of a logo with an arrow indicating the general direction of the brand access site. In addition, the present invention, while primarily discussion smartphone-type devices (e.g., Apple iPhone), the present invention anticipates systems and method involving other devices and types of devices, including but not limited to wearable communication devices, such as devices that may be worn as a headset or glasses (e.g., Google Glass), or wrist-worn devices, these devices having wireless communication means as well as means for communicating information with a user of the device.

Although certain embodiments disclosed herein are used in conjunction with mobile devices, this is not a requirement of the present invention. Rather, the techniques disclosed herein may be used in conjunction with devices that are fixed (such as desktop computers). Although certain embodiments are described herein as being used in conjunction with a wireless network connection, this is not a requirement of the present invention. Rather, the techniques disclosed herein may be used in conjunction with network communications that occur wirelessly or over wires, or more generally over any communications medium. Furthermore, the techniques disclosed herein may be used in conjunction with any appropriate network protocol. Although components of certain embodiments disclosed herein are described as communicating with each other over a network, the particular examples disclosed herein are not limitations of the present invention. For example, the location of the device may be identified by a component within the device itself or by a component external to the device which communicates with the device or with another element of the invention. This may involve a database or data repository.

The techniques described above may be implemented, for example, in hardware, software, firmware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices. Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory, for example. Storage devices suitable for tangibly embodying computer program instructions include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

What is claimed is:

1. A method comprising:
a. displaying, using a wireless communication device, a first prompt;
b. receiving, from a user of the device, an indication of a selection of the first prompt;
c. identifying a location of the device independently of any location-specifying user input to the device;
d. wirelessly communicating, using the device, first data, the first data comprising information relating to the first location of the device;
e. wirelessly receiving, using the device, second data;
f. displaying, using the device, a map image that is based at least in part on the second data, wherein the first map image describes a first area overlapping with a location in proximity to the location of the device;
g. wherein the map image comprises a first indication of a location of a first brand access site at which a first branded entity having a first brand is accessible;
h. wherein the first indication is located at a first position on the map image corresponding to the location of the first brand access site;
i. following displaying of the map image, determining that the device has relocated to a location in proximity to the first brand access site; and
j. determining that a transaction relating to the first brand has occurred.
